(19) United States
(12) Patent Application Publication
(10) Pub. No.: US 2017/0203847 A1
(43) Pub. Date: Jul. 20, 2017

(54) OCCUPANT RESTRAINT SYSTEMS HAVING EXTENDING RESTRAINTS, AND ASSOCIATED SYSTEMS AND METHODS

(71) Applicant: AmSafe, Inc., Phoenix, AZ (US)

(72) Inventors: Matthew James Browning, Gilbert, AZ (US); William Joseph Gehret, Chandler, AZ (US); Todd Humbert, Chandler, AZ (US); Richard Patterson, Twickenham (GB)

(21) Appl. No.: 15/002,237

(22) Filed: Jan. 20, 2016

(51) Int. Cl. B64D 25/02; B64D 11/06; B60R 21/16; B60R 22/26; B60R 22/12

(52) U.S. Cl. CPC B64D 25/02; B60R 22/26; B60R 22/12; B60R 21/16; B64D 11/062; B60R 2022/1806

(57) ABSTRACT

Various embodiments of vehicle occupant safety systems having extendable restraints for use with, for example, airbags are described herein. In one embodiment, for example, the disclosed technology includes a 2-point occupant restraint that secures an occupant in an aircraft seat. In this embodiment, the aircraft seat is positioned in a seating area that includes a forward monument housing a stowed airbag. In the event of a crash or other significant dynamic event that causes, for example, a rapid deceleration of the aircraft above a preset magnitude, the airbag deploys between the occupant and the monument as the dynamic forces cause the occupant to pitch forward. The forward momentum of the occupant's body creates a significant tension load in the 2-point restraint, which causes the restraint to extend by a preset amount, thereby allowing the occupant to move forward in the seat more than the occupant would have moved had the occupant been wearing a conventional, non-extending 2-point restraint. Although the occupant is allowed to move forward, the occupant remains secured to the extended restraint by means of non-extending webbing that is secured around the waist of the occupant. Allowing the occupant to move forward in this manner enables the occupant's upper torso to impact the airbag at a reduced or otherwise more favorable angle. This can reduce both the speed and the angle at which the occupant's head impacts the airbag, thereby reducing the likelihood of injury.

### TECHNICAL FIELD

The following disclosure relates generally to occupant restraint systems for use in aircraft and other vehicles and, more particularly, to occupant restraint systems having restraints configured to extend in response to a dynamic event.

### BACKGROUND

Various types of seat belt systems have been used to secure occupants in their seats in aircraft and other vehicles. Commercial aircraft, for example, typically use 2-point restraint systems (e.g., lap seat belts) to secure occupants in their seats. Airbag systems have also been used to protect passengers from strike hazards in automobiles, aircraft, and other vehicles. In automobiles, for example, airbags can be stowed in the steering column, dashboard, side panel, or other location. In the event of a collision or other dynamic event of sufficient magnitude, a sensor detects the event and transmits a corresponding signal to an initiation device (e.g., a pyrotechnic device) on an airbag inflator. This causes the inflator to release compressed gas into the airbag, rapidly inflating the airbag and deploying it in front of the driver or other occupant to protect them from impact injuries.

As noted above, commercial aircraft typically use lap seat belts to secure occupants in their seats. Conventional lap seat belts, however, do not stop the occupant's upper torso from rotating forward in a crash or other rapid deceleration event. If the occupant is seated behind another seat or a forward monument when this happens, the occupant's head may strike the forward structure. Although shoulder belts or other multi-point systems with shoulder harnesses can reduce forward head movement, substantial head movement may still occur. To address this, an airbag can be deployed in front of the occupant so that the occupant's head contacts the airbag as it rotates forward instead of the forward structure. Although the use of airbags can significantly reduce the likelihood of head or neck injury, it can be important to ensure that the occupant contacts the airbag in such a way that it does not put undue stress on the occupant's neck, head or other portion of the occupant's body. If an airbag is not present and the occupant is seated behind a monument, then it can also be important to ensure that the occupant contacts the monument in a similar way.

### BRIEF DESCRIPTION OF THE DRAWINGS

FIGS. 1A and 1B are top and side views, respectively, of an occupant secured in a vehicle seat by a standard 2-point restraint system.

FIGS. 2A and 2B are top and side views, respectively, of the occupant of FIGS. 1A and 1B after the vehicle has experienced a rapid deceleration event.

FIGS. 3A and 3B are top and side views, respectively, of an occupant secured in a vehicle seat by an extendable 2-point restraint system configured in accordance with an embodiment of the present technology.

FIGS. 4A and 4B are side and top views, respectively, of an extendable restraint system configured in accordance with an embodiment of the present technology.

FIGS. 5A and 5B are side and top views, respectively, of a portion of the extendable restraint system of FIGS. 4A and 4B prior to restraint extension, in accordance with an embodiment of the present technology.

FIGS. 6A and 6B are side and top views, respectively, of the portion of the extendable restraint system of FIGS. 5A and 5B after restraint extension, in accordance with an embodiment of the present technology.

FIG. 7A is a top view of a portion of an extendable restraint system configured in accordance with another embodiment of the present technology, prior to restraint extension, and FIG. 7B is a top view of the portion of FIG. 7A after restraint extension.

FIG. 8A is an isometric view of the extendable restraint system of FIGS. 4A-6B installed on a vehicle seat, and FIG. 8B is an isometric view of the extendable restraint system securely fastened around the waist of a seat occupant in accordance with the present technology.

FIG. 9 is an isometric view of an extendable restraint system configured in accordance with another embodiment of the present technology securely fastened around the waist of a seat occupant.

FIG. 10 is a partially schematic isometric view of an airbag system configured in accordance with an embodiment of the present technology.

### DETAILED DESCRIPTION

The following disclosure describes various embodiments of occupant restraint systems having restraints configured to increase in length during a dynamic event to more favorably position the occupant for impact with an associated airbag or forward structure. In some embodiments, the extension of the restraint occurs in response to a load on the restraint above a preset magnitude. The load can be generated by a vehicle dynamic event, such as a crash, that causes the occupant's body to shift forward against the restraint. In some embodiments, the extension of the restraint is controlled by means of a mechanical device that is actuated by the loads imparted on the restraint by the occupant's body motion. As described in greater detail below, the extension of the restraint during the dynamic event can favorably position the occupant to, for example, reduce the speed at which the occupant's head contacts an airbag or monument by allowing the occupant's torso to move forward and contact the airbag or monument before the head does. The favorable positioning of the occupant can also reduce the angle of the occupant's neck when the head makes contact with an airbag or monument, and thereby reduce the load or stress on the neck from the impact. Accordingly, various embodiments of the extendable restraint systems described herein can mitigate the potential for neck injury or other injuries resulting from impact with an airbag or forward monument by improving the position and/or orientation of the occupant relative to the airbag or monument.

In some embodiments, the restraint systems described herein can be referred to as “dual stage” or “dual stage smart” extending restraint systems because they are configured to operate in a first stage (i.e., an unextended stage) prior to a dynamic event, and then operate in a second stage (i.e., an extended stage) in response to a load imparted during a dynamic event. Various embodiments of the restraint systems described herein can include an extension mechanism which can be, for example, a feature of the restraint hardware (e.g., the hardware which attaches a web of the restraint system to a seat or vehicle hard point) or a construction within the webbing of the restraint. The extension mechanism provides a limited and controlled amount of additional length to the restraint during a crash event to allow a more ideal positioning of the occupant for contact with an airbag, forward structure, or other object.

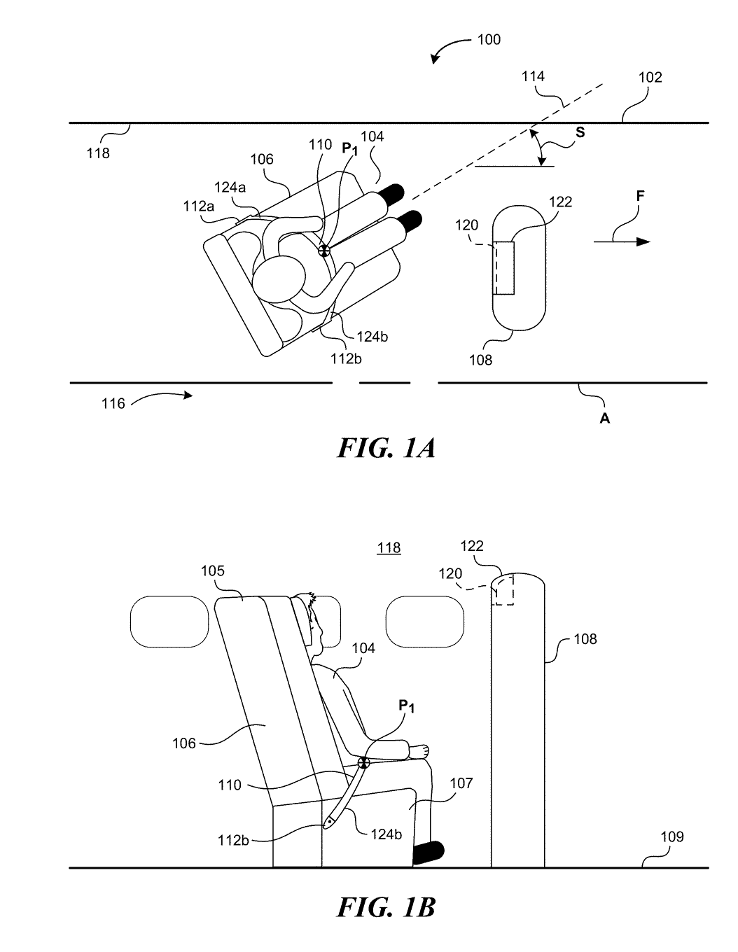

Certain details are set forth in the following description and in FIGS. 1A-10 to provide a thorough understanding of various embodiments of the disclosure. Other details describing well-known structures, materials, operations and/or systems often associated with restraint systems, seat belts, airbag systems, and related circuitry in aircraft and other vehicles are not shown or described in detail in the following disclosure to avoid unnecessarily obscuring the description of the various embodiments of the technology. Additionally, those of ordinary skill in the art will recognize that the present technology can be practiced without one or more of the details set forth herein, or with other structures, methods, components, and so forth. For example, several embodiments of occupant restraint systems are described below in the context of commercial passenger aircraft. However, the various systems and aspects thereof disclosed herein may be used in a wide variety of other vehicles, including without limitation other aircraft (e.g., private and military aircraft), ground vehicles (e.g., automobiles, trucks, buses and trains) watercraft, etc.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below. In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIGS. 1A and 1B are top and side views, respectively, of an occupant 104 secured in a vehicle seat 106 by a conventional 2-point restraint 110. Referring to FIGS. 1A and 1B together, in the illustrated embodiment the seat 106 is positioned in a seating area 100 of a commercial aircraft 102 between a passenger aisle 116 (e.g., a central aisle) and a side wall 118. The aircraft 102 has a longitudinal axis A (e.g., a centerline of the aircraft fuselage) that extends parallel to a forward direction of flight indicated by arrow F. The seat 106 can include a back portion 105 extending upwardly from a seat portion 107 fixedly mounted to a floor 109 of the aircraft 102. In one aspect of the illustrated embodiment, the seat 106 can be at least generally similar to conventional seats in, for example, a first or business class cabin of a commercial passenger aircraft or business jet. For example, the seat 106 can have a centerline 114 that is oriented at an angle S relative to the longitudinal axis A of the aircraft 102. In some embodiments, the angle S can range from about 5 degrees to about 40 degrees, or from about 10 to about 30 degrees. In other embodiments, the seat 106 can be positioned in other orientations and/or other settings in the aircraft 102. For example, in other embodiments the seat centerline 114 can be facing directly forward as indicated by arrow F and parallel to, or at least approximately parallel to, the longitudinal axis A. Additionally, as those of ordinary skill in the art will appreciate, although only one seat 106 is illustrated in FIGS. 1A and 1B, in other embodiments, additional seats can be positioned to one or both sides of the seat 106 to comprise a row of seats in the aircraft 102. In other embodiments, the restraint systems described herein can be used to protect occupants in other types of vehicles, including other types of aircraft (e.g., both fixed- and rotary-wing aircraft), land vehicles (e.g., automobiles), watercraft, etc.

The 2-point restraint 110 is a lap seat belt having a first web portion 124a and a corresponding second web portion 124b. A proximal end of the first web portion 124a is fixedly attached to a seat structure (e.g., a seat base, frame, etc.) on one side of the seat 106 by a first attachment fitting 112a, and the proximal end of the second web portion 124b is similarly attached to the seat structure on the opposite side of the seat 106 by a second attachment fitting 112b. The distal end of the first web portion 124a can carry a conventional web connector having a tongue portion (not shown), and the distal end of the second web portion 124b can carry a corresponding buckle assembly (also not shown) configured to receive and releasably engage the connector tongue to securely couple the two web portions 124a, 124b together around the waist of the seat occupant 104 in a conventional manner known in the art. As shown in FIGS. 1A and 1B, when the occupant 104 is positioned in the seat 106 in a normal, upright seating position and properly secured by the restraint 110, the position of the occupant's body can be represented by a first point P₁ which, for purposes of illustration, is generally located in the center of the occupant 104 where the restraint 110 extends across the occupant's waist.

In another aspect of this embodiment, the seating area 100 includes a structure 108 at least partially separating the seating area 100 from the seating area in front of it. In the illustrated embodiment, the structure 108 is a monument fixedly attached to the floor 109 of the seating area 100 adjacent to the aisle 116. The structure 108 is generally positioned forward of the seat 106 in the direction F, but slightly offset from the seat centerline 114. As those of ordinary skill in the art will understand, in other embodiments the seating area 100 can include other types of structures having the same or other positions relative to the seat 106 including, for example, other types of monuments (e.g., partitions, closets, bar units, seat ottomans, etc.), divider walls, galley walls, and other objects. Similarly, in other embodiments the structure 108 can be a seat back of a seat positioned directly in front of the seating area 100. In yet other embodiments, the structure 108 can be omitted.

In the illustrated embodiment, the structure 108 can include an airbag housing 122 positioned toward an upper portion thereof. As described in greater detail below, the housing 122 can provide a suitable enclosure for an airbag 120 which is folded and stowed within the housing 122 in FIGS. 1A and 1B. In other embodiments, the stowed airbag 120 can be positioned in, or carried by, other structures, such as other monuments, a seat back positioned forward of the seat 106, a structure mounted to the side wall 118, and/or otherwise positioned forward, or at least generally forward of the seat 106. As described in greater detail below, the airbag 120 can be deployed through an opening in the housing 122 and toward the seat 106 during a crash or other rapid deceleration event so that the occupant's head will strike the airbag 120 and not the structure 108, thereby reducing the likelihood of injury.

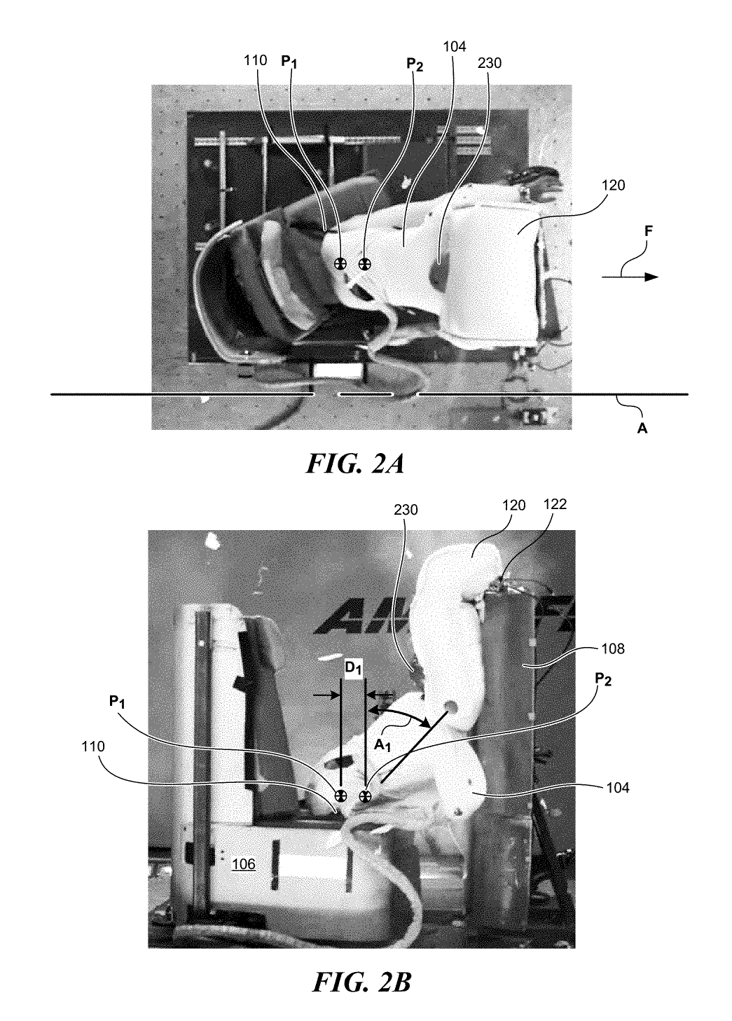

FIGS. 2A and 2B are top and side views, respectively, of the seating area 100 immediately after the aircraft 102 has experienced a dynamic event. The dynamic event can, for example, be an accident, collision, or other dynamic event that causes a rapid deceleration (or acceleration) in a direction parallel to the longitudinal axis A (e.g., a deceleration greater than about 10 g's but less than about 20 g's, such as 15 g's). As described in greater detail below, an airbag system can include a crash sensor that senses the vehicle deceleration (or acceleration) and sends a corresponding signal to an airbag deployment circuit which in turn activates an inflator, causing the inflator to discharge compressed gas into the airbag 120. The compressed gas inflates the airbag 120 and causes it to deploy from the housing 122 and into position between the occupant 104 and the monument 108 as shown in FIGS. 2A and 2B. The airbag 120 and/or the operational systems associated therewith can be at least generally similar in structure and function to one or more of the airbags and associated systems described in U.S. patent application Ser. No. 14/505,277, filed Oct. 2, 2014, and titled ACTIVE POSITIONING AIRBAG ASSEMBLY AND ASSOCIATED SYSTEMS AND METHODS; U.S. patent application Ser. No. 13/424,197, filed Mar. 19, 2012, now U.S. Pat. No. 8,523,220, and titled STRUCTURE MOUNTED AIRBAG ASSEMBLIES AND ASSOCIATED SYSTEMS AND METHODS; U.S. patent application Ser. No. 14/384,655, filed Sep. 11, 2014, and titled STRUCTURE MOUNTED AIRBAG ASSEMBLIES AND ASSOCIATED SYSTEMS AND METHODS; U.S. Provisional Patent Application No. 62/139,684, filed Mar. 28, 2015, and titled EXTENDING PASS-THROUGH AIRBAG OCCUPANT RESTRAINT SYSTEMS, AND ASSOCIATED SYSTEMS AND METHODS; U.S. Provisional Patent Application No. 62/146,268, filed Apr. 11, 2015, and titled ACTIVE AIRBAG VENT SYSTEM; each of which is incorporated herein in its entirety by reference.

As shown in FIGS. 2A and 2B, when the vehicle experiences a crash or other significant dynamic event that results in a rapid deceleration, the occupant's upper torso instantly rotates forward about the restraint 110 in the direction F. Additionally, the rapid declaration also causes the occupant's body to instantly shift (e.g., slide) forward in the seat 106 a distance D₁ from the first point P₁ to the second point P₂. As best seen in FIG. 2B, this relatively small amount of forward motion of the occupant's waist causes the occupant's upper torso to contact the airbag 120 at a relatively steep angle A₁. In some embodiments, the angle A₁ can be from about 35 degrees to about 60 degrees, or from about 40 degrees to about 50 degrees relative to the vertical direction. This positioning can cause the occupant's head 230 to contact the airbag 120 before, or at least substantially before, the occupant's upper torso or shoulder area contacts the airbag. In some instances, the occupant's upper torso may not contact the airbag 120 at all. Impacting the airbag 120 in this way can cause the occupant's head 230 to be placed at a relatively sharp angle relative to the occupant's upper torso, which can put undue stress on the occupant's neck.

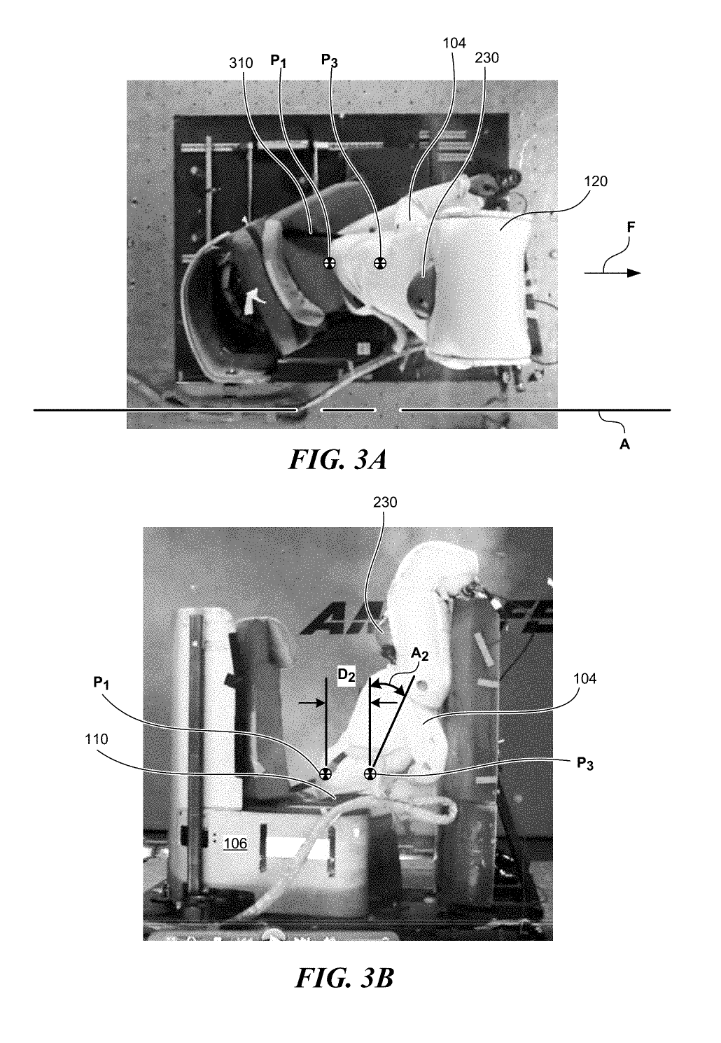

FIGS. 3A and 3B are top and side views, respectively, of the occupant 104 secured to the seat 106 during a dynamic event by an extending restraint 310 configured in accordance with an embodiment of the present technology. In FIGS. 3A and 3B, the occupant 104 is depicted in substantially the same dynamic circumstances as the occupant 104 is depicted in FIGS. 2A and 2B. More specifically, in both scenarios the aircraft 102 was moving forward in direction F and experienced an equivalent, or an at least approximately equivalent, dynamic event (e.g., a crash) resulting in a rapid deceleration acting parallel to the longitudinal axis A (and opposite to the direction F). In the embodiment of FIGS. 3A and 3B, however, the restraint 310 is a 2-point extendable restraint that, as described in greater detail below, is configured to extend a preset amount when subjected to a predetermined tension load (e.g., a tension load caused by the inertia of the occupant's moving body). Thus, the extension of the restraint 310 only occurs during a dynamic event of sufficient magnitude, thereby allowing the occupant's body to move forward in the seat 106 more than the body would otherwise move with a conventional 2-point restraint, such as the restraint 110 described above with reference to FIGS. 1A-2B.

By way of example, the extendable restraint 310 enables the occupant's waist to move forward in the direction F a distance D₂ from the first point P₁ to a third point P₃. As can be seen by a comparison of the distance D₂ in FIG. 3B to the distance D₁ in FIG. 2B, the extendable restraint 310 enables the occupant 104 to move forward a greater distance than the conventional restraint 110, thereby positioning the occupant 104 closer to the structure 108. As further illustrated in FIG. 3B, this positioning allows the occupant's upper torso to contact the airbag 120 at a relatively shallow angle A₂. In some embodiments, the angle A₂ can be from about 5 degrees to about 50 degrees, or from about 10 degrees to about 35 degrees relative to the vertical direction. This positioning also allows the occupant's upper torso and/or shoulder area to contact the airbag 120, in addition to the occupant's head 230. By distributing the airbag impact load over the occupant's torso and head, the portion of the impact load on the occupant's head 230 is reduced. Additionally, by reducing the angle of the occupant's torso from the angle A₁ in FIG. 2B to the angle A₂ in FIG. 3B, the angle of the occupant's neck is reduced at impact with the airbag 120, thereby further reducing the impact load on the occupant's neck and the potential for injury. Accordingly, extendable restraint systems configured in accordance with the present technology, when used in combination with an airbag, such as the airbag 120, can reduce the angle of the occupant's torso relative to the airbag at impact, and can enable the occupant's upper torso to contact the airbag 120 along with the occupant's head 230. In some embodiments, these features can advantageously reduce the head strike angle and the head strike speed when the occupant's head strikes the airbag, thereby reducing the load and stress on the occupant's head and neck (and hence the likelihood of injury) from a dynamic event.

The favorable occupant positioning features provided by the extendable restraints described herein are not limited to use with airbag systems, but can also improve positioning of the occupant's torso when impacting a fixed monument, a seat back, and/or other structural strike hazard positioned in front of or otherwise in the path of the restrained occupant in the absence of an airbag. In addition to controlling the position of the occupant 104 during a crash or other significant dynamic event, in some embodiments the restraint 310 can also be configured to absorb a substantial amount of the kinetic energy from the forward motion of the occupant's body. Absorbing the energy from the rapid deceleration of the occupant's body can also reduce the speed at which the occupant's upper torso and/or head 230 impacts the airbag 120, thereby further reducing the potential for injury.

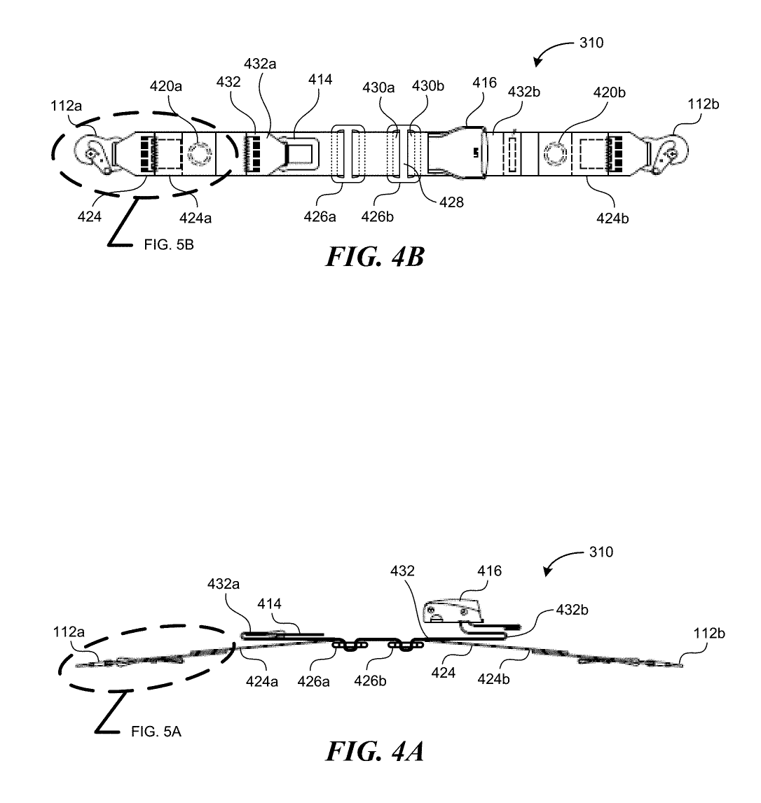

The restraint 310 can include various types of mechanisms and/or other features to control the amount of restraint extension that occurs in response to a dynamic event greater than a certain magnitude. FIGS. 4A and 4B, for example, are side and top views, respectively, of the restraint 310 illustrating a first extension feature 420a and a second extension feature 420b configured in accordance with an embodiment of the present technology. Referring to FIGS. 4A and 4B together, the restraint 310 of the illustrated embodiment includes a first web 424 and a second web 432. A first attachment fitting 112a is attached (via, e.g., a loop of webbing) to a first end portion 424a of the first web 424, and a second attachment fitting 112b is similarly attached to a second end portion 424b of the first web 424. The attachment fittings 112a, b can be conventional hook-type fittings known in the art for securing seat belt webs to anchor points (e.g., a bolt, bar, hook, etc.) on seat frames or other adjacent structures. A web connector having a tongue portion 414 is fixedly attached to a first end portion 432a of the second web 432, and a corresponding buckle assembly 416 (e.g., a conventional seat belt buckle known in the art) is attached to a second end portion 432b of the second web 432. The buckle assembly 416 can be a conventional seat belt buckle configured to releasably engage the web connector tongue portion 414 in conventional manner well known in the art. In some embodiments, the buckle assembly 416 can be coupled to the second end portion 432b by routing the second end through a passage in the buckle assembly 416 that enables the seat occupant to manually adjust the length of the second web 432 as needed to securely fasten the second web 432 about the occupant's waist in a conventional manner. By way of example, the webs 424 and 432 can be at least generally similar in structure and function to conventional seat belt webs formed from, for example, woven nylon webbing. In other embodiments, the webs 424 and 432 can be formed from other materials of suitable strength and flexibility.

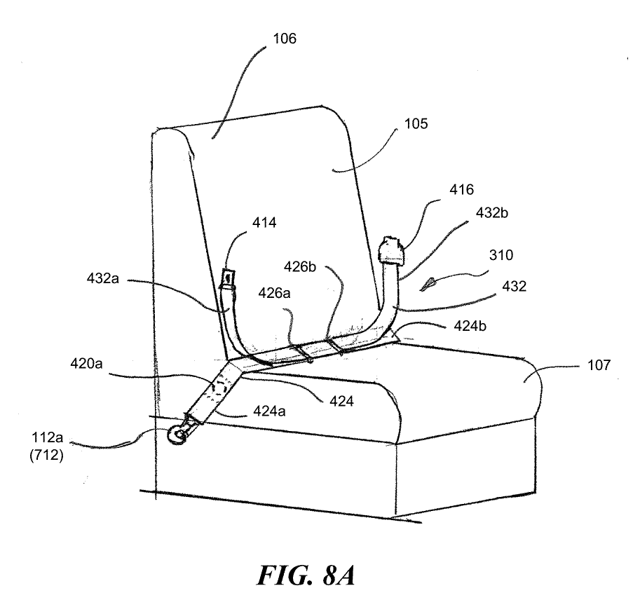

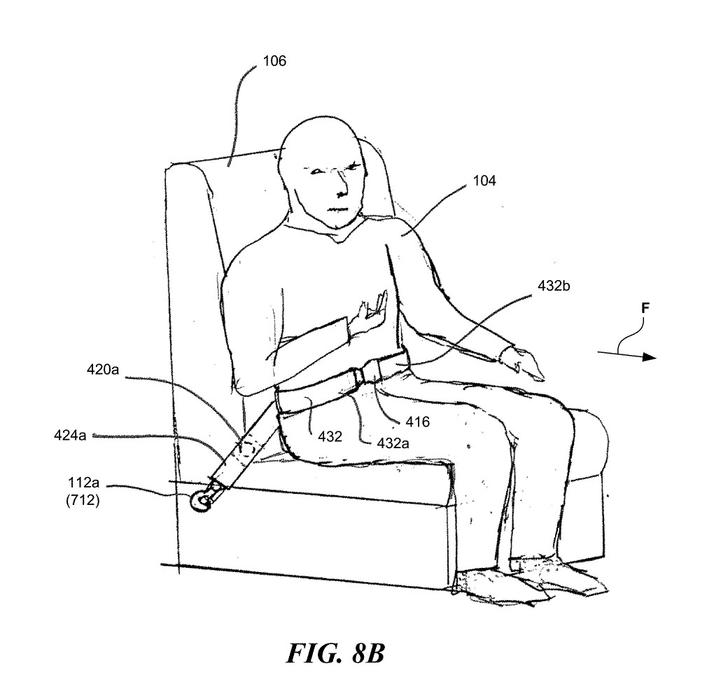

In the illustrated embodiment, the restraint 310 further includes a first web clip 426a and a second web clip 426b. The web clips 426a, b are essentially identical, and each includes a bar 428 extending across a center portion thereof to define a first passage 430a to one side of the bar 428 and a second passage 430b to the other side of the bar 428. In the illustrated embodiment, both the first web 424 and the second web 432 are routed through the first and second passages 430a, b and around the bar 428 of each web clip 426a, b to position the web clips 426a, b on the first web 424 and the second web 432 as shown in FIGS. 4A and 4B. As described in greater detail below with reference to FIGS. 8A and 8B, the purpose of the web clips 426a, b is to securely attach the second web 432 (which will extend around the occupant's waist) to the first web 424 (which will be securely attached to the seat base or other mounting structure). When the first web 432 is properly secured around the waist of a seat occupant, the web clips 426a, b will positioned against, or at least adjacent to, the occupant's lower back. To avoid the occupant discomfort that could result from using single clip located in a center potion of the occupant's back, the restraint 310 of the illustrated embodiment includes two of the web clips 426a, b which are spaced apart from each other. In other embodiments, the web clips 426a, b can be padded, or they can located within the seat back 105 behind the seat cover and/or padding. In further embodiments, a single web clip can be used. In yet other embodiments, the second web 432 can be attached to the first web 424 by other suitable means, such as by stitching, fasteners, adhesive, etc.

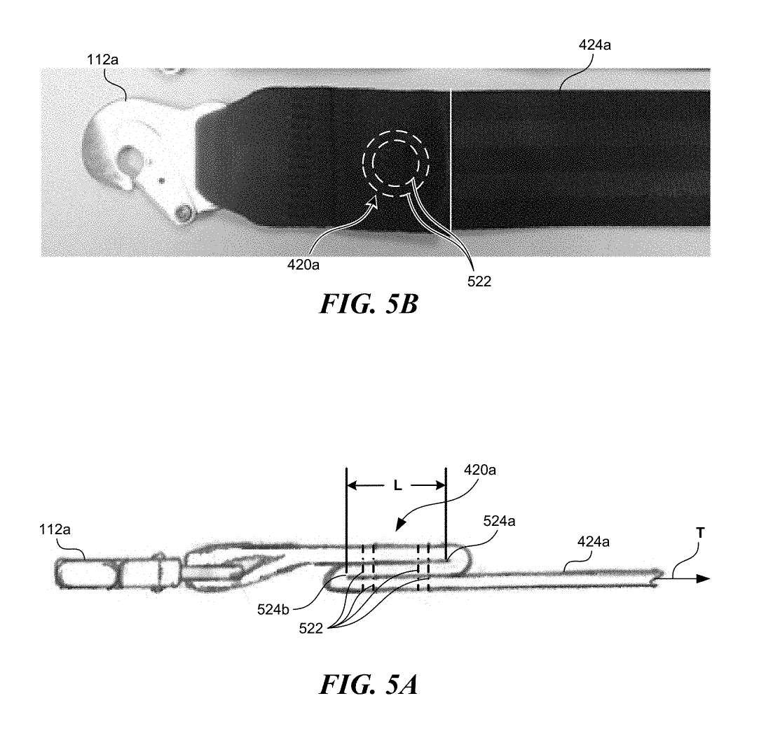

FIGS. 5A and 5B are enlarged side and top views, respectively, of a portion of the first web portion 424a for the purpose of illustrating the structure and function of the first extension feature 420a. Although not shown in FIGS. 5A and 5B, the second web extension feature 420b can be at least generally similar in structure and function to the first web extension feature 420a. Referring to FIGS. 5A and 5B together, to form the first web extension feature 420a, the first web portion 424a is first doubled over on itself in a “Z-fold” about a first fold line 524a and a second fold line 524b as shown in FIG. 5A. The fold lines 524a, b can be spaced apart by a distance L. In some embodiments, the distance L can range from about 1 inch to about 2.5 inches, or from about 1.5 inches to about 2 inches. The folded-over web is then fastened together. For example, in the illustrated embodiment the folded-over web portion is fastened together by stitching 522. The stitching can include thread, such as nylon thread. As described in greater detail below, the tensile strength of the thread used in the stitching 522 and/or the number of stitches and/or the type of stitch pattern can be selected so that the stitching 522 will rupture and release the folded-over web portion when a preset tension load T is applied to the first web portion 424a. The tension force T can be selected to correspond to an inertial force that would be imparted to the first web portion 424a when the occupant experiences a vehicle dynamic event (e.g., a rapid deceleration) above a preset magnitude or threshold which in turn causes the occupant's body to be thrown forward against the restraint 310 as shown in FIGS. 3A and 3B. For example, the stitching 522 can be selected and designed to rupture and permit unfolding of the web when the tension force T is from about 200 pounds to about 600 pounds, or about 400 pounds. Selecting a tension force T in this range would prevent the stitching 522 from rupturing under any type of normal usage, but would also easily rupture during a selected dynamic event, such as a deceleration of 15 g's or more. In one aspect of this embodiment, the extension feature 420a can also absorb some of the kinetic energy from the occupant's rapid movement during the dynamic event, and thereby further reduce the impact load on the occupant when the occupant's upper torso and/or head contact the airbag 120 or directly contact a forward monument. When it is desirable for the extension feature to additionally act as an energy absorber, the stitching 522 can be configured to rupture at a higher load than described above, such as a load ranging from about 400 pounds to about 800 pounds, or about 600 pounds.

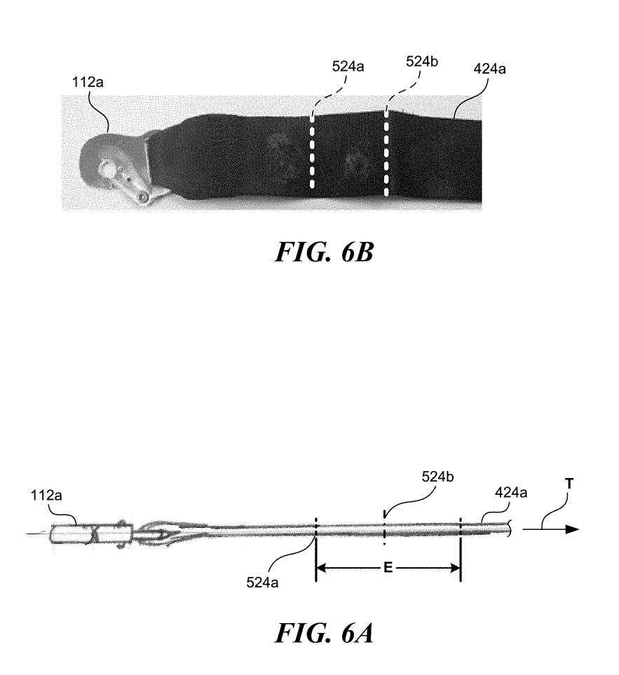

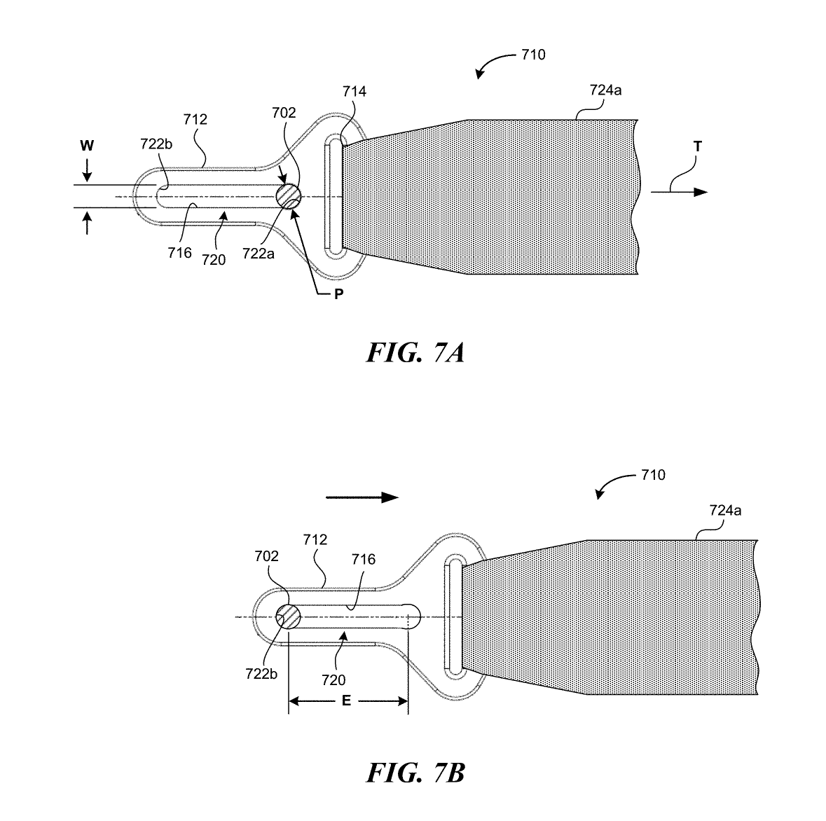

FIGS. 6A and 6B are side and top views, respectively, of the first web portion 424a after the first web portion 424a has sustained a tension load T of sufficient force to rupture the extension feature 420a (e.g., a tension force of about 400 pounds). When the extension feature 420a ruptures or otherwise releases the folded web portions, the first web portion 424a is pulled straight, increasing in length by two times the distance L, which is represented by an extension distance E. If the fold distance L shown in FIG. 5A is selected to be from about 1 inch to about 2.5 inches, then the web extension distance E will be from about 2 inches to about 5 inches once the first web portion 424a is fully extended. In those embodiments in which the second web portion 424b includes a web extension feature (e.g., the second web extension feature 420b) that is structurally equivalent or at least generally similar to the first web extension feature 420a, then the entire restraint 310 will undergo a total extension of from about 4 inches to about 10 inches in response to the dynamic event. In some embodiments, an overall increase in length of the restraint 310 of from about 4 inches to about 10 inches will correspond to a forward movement of the occupant's waist of from about 2 inches to about 5 inches, or about 4 inches. Accordingly, with reference to FIGS. 2A-3B described above, use of the extendable restraint 310 instead of the conventional restraint 110 allows the occupant 104 to move in the forward direction F about 2 to 5 inches further than the occupant 104 would otherwise move if secured in the seat 106 by the conventional restraint 110. In other embodiments, restraints configured in accordance with the present technology can include one or more extension features that provide other extension distances E to provide more or less forward movement of the occupant in response to dynamic events. (It should be noted that, although the restraint 110 (FIGS. 1A and 1B) is not an “extendable” restraint in the sense that it does not include an extension mechanism, such as the Z-fold described above, the restraint 110 still allows the occupant 104 to move forward in the direction F the relatively small distance D₁ due to stretching of the web portions 124a, b under load and/or compression of the occupant's waist from the tension in the restraint 110.)

The extension feature 420a described above with reference to FIGS. 4A-6B is but one type of extension mechanism that can be incorporated into the restraint 310 to provide the desired extension under load. In other embodiments, other types of extension features and mechanisms can be used. For example, FIGS. 7A and 7B are enlarged top views of a portion of a 2-point restraint 710 that includes a web attachment fitting 712 having an extension feature 720 configured in accordance with another embodiment of the present technology. In the illustrated embodiment, the restraint 710 can include a first web portion 724a securely attached to the attachment fitting 712 in a conventional manner (e.g., by looping the web 718 through an aperture in the attachment fitting 712 and then stitching the web onto itself). Although not shown, the restraint 710 can also include a second web portion attached to another of the attachment fittings 712 in a similar manner.

In the illustrated embodiment, the extension feature 720 includes an elongate channel or slot 716 that extends through the attachment fitting 712 and is oriented in general alignment with the web portion 724a. The slot 716 has a width W and a first end portion 722a spaced apart from a second end portion 722b by an extension length E. In one aspect of this embodiment, the first end portion 722a can be partially circular and have a diameter that is slightly larger than the slot width W to accommodate a bolt 702, which has a diameter P that is also slightly larger than the slot width W but just slightly smaller than, or equal to, the diameter of the first end potion 722a. This enables the attachment fitting 712 to pivot about the bolt 702 as needed for alignment of the end portion 718 in normal use. Additionally, because the bolt 702 is larger in diameter than the slot width W, under normal operating conditions the attachment fitting 712 can rotate about the bolt 702 but it cannot translate relative to the bolt 702.

In the normal operating mode and prior to extension, the bolt 702 extends through the first end portion 722a and fixedly attaches the proximal end of the web portion 724a to an anchor point on a seat structure (or nearby vehicle structure; not shown). However, when the web portion 724a experiences a tension load above a predetermined magnitude (e.g., above 400 pounds) resulting from a sudden forward acceleration of the seat occupant's body during a dynamic event, the tension load causes the bolt 702 to bear against the sidewalls of the slot 716 and deform them slightly outward. This slight increase in slot width enables the bolt 702 to move through the slot 716 as the attachment fitting 712 translates in the direction of the tension force T, until the bolt 702 is positioned against the second end portion 722b of the slot 716 as shown in FIG. 7B. In the foregoing manner, the slot width W relative to the diameter P of the bolt 702 can be sized to control the tension force T required to move the attachment fitting 712 relative to the bolt 702, and the length of the slot 716 can be selected to control the amount of extension E of the restraint 710 in response to the dynamic event. For example, in those embodiments in which the opposite end of the restraint 710 is attached to the seat (or other structure) with another of the attachment fitting 712, the distance E can be selected to range from about 2 inches to about 5 inches, resulting in an overall increase in length of the restraint 710 of from about 4 inches to about 10 inches, which in turn allows the seat occupant to move forward in the direction F (FIG. 3A) a distance of from about 2 inches to about 5 inches during the dynamic event.

FIG. 8A is an isometric view of the extendable restraint 310 installed on the vehicle seat 106, and FIG. 8B is an isometric view of the extendable restraint 310 with the second web 432 securely fastened around the waist of the occupant 104 in accordance an embodiment of the present technology. Referring to FIGS. 8A and 8B together, the restraint 310 is attached to the seat 106 by securely attaching the respective attachment fittings 112a, b on the first web 424 to corresponding anchor points on the seat frame or other fixed structure on opposite sides of the seat 106. The length of the first web 424 is sized so that it extends tightly across the seat 106 proximate the junction between the seat back 105 and the seat base 107 without any appreciable slack.

In some embodiments, the second web 432 can be secured around the waist of the occupant 104 in a conventional manner. More specifically, after the occupant 104 has sat down in the seat 106, the occupant 104 can grasp the connector tongue 414 in one hand and the buckle assembly 416 in the other hand, and then insert the tongue 414 into the buckle assembly 416 to couple the two parts together in a conventional manner. After the tongue portion 414 has been engaged with the buckle assembly 416, the occupant 104 can pull on the loose end of the second end portion 432b as required to adjust the tension in the second web 432 so that it fits snuggly around the occupant's waist. The restraint can be released by lifting a handle on the buckle assembly 416 in a conventional manner.

If the aircraft experiences a collision or other rapid deceleration greater than a preset magnitude (e.g., greater than 15 g's), the tension force in the first web 424 caused by the forward momentum of the occupant's body in the direction F releases the first and second extension features 420a, b to thereby extend the first web 424 as described above with reference to FIGS. 5A-6B. This enables the occupant 104 to shift slightly forward in the seat 106 to better position the occupant 104 for impact with an associated airbag or a forward structure, as described above with reference to FIGS. 3A and 3B. Although the dynamic event causes the first web 424 to extend, the second web 432 is a “non-extending web” that remains relatively tight or snug around the occupant because the second web 432 of this embodiment does not include any extension features. In some embodiments, keeping the second web 432 relatively tight while allowing the first web 424 to extend can provide better control of the occupant's body after the occupant 104 impacts the airbag or a forward structure.

In other embodiments, the extendable attachment fitting 712 described above with reference to FIGS. 7A and 7B can be used to provide extension of the restraint 310 during a dynamic event. For example, in one such embodiment the attachment fittings 112a, b can be replaced by two of the attachment fitting 712 and the extension features 420a, b in the first web 424 can be omitted. In other embodiments, more extension of the restraint may be required to reduce or prevent injury. In such embodiments, the attachment fittings 712 can be used in addition to the extension features 420a, b (and/or other extension mechanisms) to provide a controlled amount of web extension during a dynamic event.

In some embodiments, less forward movement of the occupant than is provided by an extension mechanism (such as the extension features 420 or the attachment fittings 712) may be sufficient to prevent or reduce injury from impacting an airbag or strike hazard (e.g., a monument) in an unfavorable orientation. In such embodiments, the restraint 310 shown in FIGS. 4A and 4B without any extension mechanisms (e.g., 420a and 420b) can be used as shown in FIGS. 8A and 8B to provide enough forward movement of the occupant 104 to prevent or reduce injury. In this case, the configuration of the restraint 310 allows the kinetic movement of the occupant during impact to stretch the web portions of the restraint 310 and allow sufficient forward movement to prevent or reduce injury.

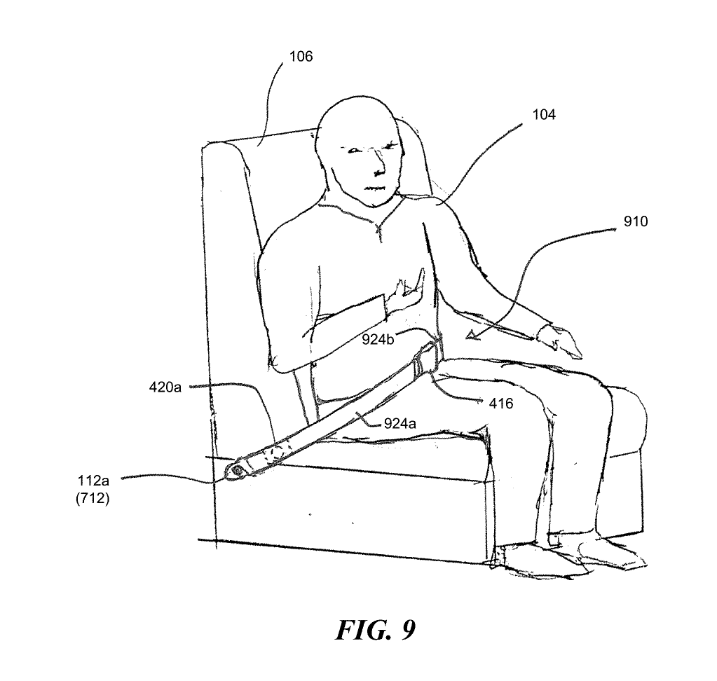

FIG. 9 is an isometric view of the occupant 104 secured in the seat 106 by an extendable restraint 910 configured in accordance with another embodiment of the present technology. In the illustrated embodiment, the restraint 910 is a 2-point restraint (e.g., a lap seat belt) having a first web portion 924a and a second web portion 924b. In one aspect of this embodiment, each of the first and second web portions 924a, b can include a corresponding web extension feature 420a, b as described in detail above with reference to FIGS. 4A-6B (the second extension feature 420b is not visible in FIG. 9). The proximal end of the first web portion 924a is attached to the seat frame by a first attachment fitting 112a, and the proximal end the second web portion 924b can be similarly attached to the seat frame on the opposite side of the occupant 104. The distal end of the first web portion 924b can carry a web connector having a tongue portion (not shown), and the distal end of the second web portion 924b can carry a corresponding buckle assembly 416. The tongue portion of the web connector can be releasably engaged with the buckle assembly 416 to secure the restraint 910 around the occupant's waist in a conventional manner as shown in FIG. 9.

If the aircraft experiences a collision or other rapid deceleration greater than a preset magnitude (e.g., greater than 15 g's), the tension force in the first and second web portions 924a, b caused by the forward momentum of the occupant's body causes the first and second extension features 420a, b to rupture, thereby enabling the restraint 910 to extend as described above with reference to FIGS. 5A-6B. This enables the occupant 104 to shift slightly forward in the seat 106 to better position the occupant 104 for impact with an associated airbag or a forward structure, as described above with reference to FIGS. 3A and 3B. In other embodiments, the extendable attachment fitting 712 described above with reference to FIGS. 7A and 7B can be used to provide extension of the restraint 910 during a dynamic event. For example, in one such embodiment the attachment fittings 112a, b can be replaced by two of the attachment fittings 712 and the extension features 420a, b in the first and second web portions 924a, b can be omitted. In other embodiments, the attachment fittings 712 can be used in addition to the extension features 420a, b to provide a preset amount of web extension during a dynamic event.

The foregoing are provided by way of examples of suitable restraint arrangements that can be used with the present technology. In other embodiments, the various types of web extension mechanisms and features described herein can be used with other types of seat belt webs having other arrangements, and/or other types of attachment fittings, connectors, and/or buckle assemblies. For example, in other embodiments one or more of the web extension features described herein can be used with a 3-point shoulder seat belt arrangement, a 5-point seat belt arrangement, a “Y-belt” arrangement, etc.

Although two types of extension mechanisms have been described above with reference to FIGS. 4A-9, various other types of extension mechanisms, systems, and/or features can be incorporated into the extendable restraint systems described herein to provide the desired amount of extension in response to a dynamic event. For example, with reference to FIGS. 4A and 4B, in other embodiments, rather than use the attachment fittings 112 at opposite ends of the restraint 310, the restraint 310 can utilize one or more web retractors that are configured to allow a preset portion of webbing to spool out when the restraint experiences a tension load above a preset magnitude resulting from a dynamic event. For example, such retractors can include either motorized or mechanical retraction or locking mechanisms that either mechanically react to the tension load to payout web, or respond to an electronic signal from a control unit during a dynamic event to automatically payout web. In yet other embodiments, extendable restraint systems configured for use with, for example, airbag systems as described herein can include one or more of the extension mechanisms and/or systems described in U.S. patent application Ser. No. 13/441,689, filed Apr. 6, 2012, and titled PERSONAL RESTRAINT SYSTEMS FOR USE IN RECREATIONAL UTILITY VEHICLES AND OTHER VEHICLES, which is incorporated herein in its entirety by reference. These other types of extension mechanisms and/or systems can be used in place of, or in addition to, the extension features 420, 720 described in detail herein. Accordingly, aircraft occupant safety systems configured in accordance with the present technology are not limited to use with the various extension mechanisms and features described herein, but can include various other types of suitable extension mechanisms without departing from the spirit or intent of the present disclosure.

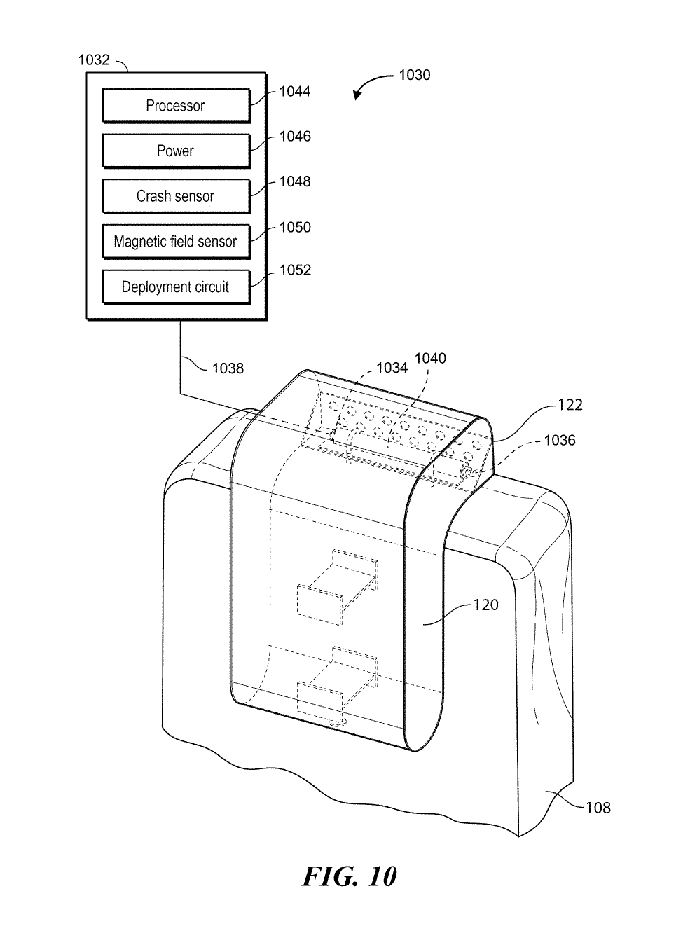

FIG. 10 is a partially schematic isometric view of an upper portion of the structure 108 and an airbag inflation system 1030 configured in accordance with an embodiment of the present technology. In the illustrated embodiment, the airbag inflation system 1030 includes an electronic assembly 1032 (e.g., an electronic module assembly (EMA); shown schematically) and an airbag inflator 1040 positioned within the airbag 120. The airbag inflator 1040 can include an initiator 1034 (e.g., a pyrotechnic initiator, such as a squib) operably positioned on one end, and a diffuser 1036 positioned on the opposite end. The electronic assembly 1032 can be electrically coupled to the initiator 1034 via an electrical link 1038. In the illustrated embodiment, the electronic assembly 1032 includes a processor 1044 that receives electrical power from a power source 1046 (e.g., one or more batteries, such as lithium batteries), a deployment circuit 1052 that initiates the inflator 1040, and at least one crash sensor 1048 (e.g., an accelerometer) that detects rapid decelerations and/or other dynamic events greater than a preset or predetermined magnitude. The crash sensor 1048 can, for example, include a spring-mass damper type sensor with an inertial switch calibrated for the vehicle's operating environments that initiates airbag deployment upon a predetermined level of deceleration. In other embodiments, the crash sensor 1048 can include other types of sensors known in the art. Optionally, the electronics assembly 1032 can also include one or more magnetic field sensors 1050 that can detect the presence of an external magnetic field and communicate with the processor 1044 to deactivate the crash sensor 1048 and prevent inadvertent deployment of the airbag 120. In other embodiments, the electronic assembly 1032 can include other sensors and/or other additional features to facilitate airbag deployment, and/or some of the components of the electronic assembly 1032 may be omitted. In certain embodiments, for example, the electronic assembly 330 can include only the power source 1046 and the crash sensor 1048, which completes a circuit to activate the inflator 1040 in the event of a vehicle collision or other significant dynamic event.

In a dynamic event above a predetermined threshold (e.g., an acceleration/deceleration of a certain magnitude resulting from a vehicle crash, accident, or other significant dynamic event), the crash sensor 1048 can respond by sending a signal to the processor 1044 which causes the processor 1044 to send a corresponding signal to the deployment circuit 1052. Upon receiving the signal from the processor 1044, the deployment circuit 1052 can apply a sufficient voltage to the inflator initiator 1034 via the electrical link 1038 to activate the initiator 1034, which in turn causes the inflator 1040 to discharge its compressed gas into the airbag 120 via the diffuser 1036. The expansion of the compressed gas rapidly inflates the airbag 120 and causes it to deploy as described above. In other embodiments, the inflator 1040 can be spaced apart from the airbag 120 and be fluidly coupled thereto by a gas delivery hose (not shown) and/or other suitable fluid passageway. For example, in some embodiments the inflator 1040 can be positioned remotely from the airbag housing 122, and one end of a suitable gas delivery hose can be coupled to the inflator 1040 in place of the diffuser 1036. An opposite end of the gas delivery hose can then be positioned in fluid communication with the interior of the airbag 120, such that upon activation of the inflator 1040 the compressed gas will pass through the delivery hose and rapidly inflate the airbag 120 as described above. The airbag deployment and inflation systems described above are provided by way of example of one such suitable airbag system. It should be noted that the various embodiments of airbags described herein are not limited to the particular airbag configuration shown nor the deployment and inflation system described above, but can also be used with other types of airbags and deployment and inflation systems and, accordingly, are not limited to those described above.

Each of the following applications and patents is incorporated herein by reference in its entirety: U.S. patent application Ser. No. 09/143,756, filed Aug. 13, 1998, now U.S. Pat. No. 5,984,350, titled VEHICLE SAFETY SYSTEM; U.S. Pat. No. application Ser. No. 10/672,606, filed Sep. 26, 2003, now U.S. Pat. No. 6,957,828, titled INFLATABLE LAP BELT SAFETY BAG; U.S. Pa. No. application Ser. No. 09/253,874, filed Mar. 13, 2000, now U.S. Pat. No. 6,439,600, titled SELF-CENTERING AIRBAG AND METHOD FOR MANUFACTURING AND TUNING THE SAME; U.S. patent application Ser. No. 09/523,875, filed Mar. 13, 2000, now U.S. Pat. No. 6,535,115, titled AIR BAG HAVING EXCESSIVE EXTERNAL MAGNETIC FIELD PROTECTION CIRCUITRY; U.S. patent application Ser. No. 09/524,370, filed Mar. 14, 2000, now U.S. Pat. No. 6,217,066, titled MULTIPLE INFLATOR SAFETY CUSHION; U.S. patent application Ser. No. 12/057,295, filed Mar. 27, 2008, now U.S. Pat. No. 7,665,761, titled INFLATABLE PERSONAL RESTRAINT SYSTEMS AND ASSOCIATED METHODS OF USE AND MANUFACTURE; U.S. patent application Ser. No. 12/051,768, filed Mar. 19, 2008, now U.S. Pat. No. 7,980,590, titled INFLATABLE PERSONAL RESTRAINT SYSTEMS HAVING WEB-MOUNTED INFLATORS AND ASSOCIATED METHODS OF USE AND MANUFACTURE; U.S. patent application Ser. No. 13/608,959, filed Sep. 10, 2012, titled ELECTRONIC MODULE ASSEMBLY FOR INFLATABLE PERSONAL RESTRAINT SYSTEMS AND ASSOCIATED METHODS; U.S. patent application Ser. No. 13/170,079, filed Jun. 27, 2011, now abandoned, titled SENSORS FOR DETECTING RAPID DECELERATION/ACCELERATION EVENTS; U.S. patent application Ser. No. 13/194,411, filed Jul. 29, 2011, now U.S. Pat. No. 8,439,398, titled INFLATOR CONNECTORS FOR INFLATABLE PERSONAL RESTRAINTS AND ASSOCIATED SYSTEMS AND METHODS; U.S. patent application Ser. No. 13/227,392, filed Sep. 7, 2011, now U.S. Pat. No. 8,556,293, titled BUCKLE CONNECTORS FOR INFLATABLE PERSONAL RESTRAINTS AND ASSOCIATED METHODS OF USE AND MANUFACTURE; U.S. patent application Ser. No. 13/086,134, filed Apr. 13, 2011, now U.S. Pat. No. 8,469,397, titled STITCH PATTERNS FOR RESTRAINT-MOUNTED AIRBAGS AND ASSOCIATED SYSTEMS AND METHODS; U.S. patent application Ser. No. 13/227,382, filed Sep. 7, 2011, now U.S. Pat. No. 8,403,361, titled ACTIVATION SYSTEMS FOR INFLATABLE PERSONAL RESTRAINT SYSTEMS; U.S. patent application Ser. No. 13/174,659, filed Jun. 30, 2011, titled INFLATABLE PERSONAL RESTRAINT SYSTEMS; U.S. patent application Ser. No. 13/228,333, filed Sep. 8, 2011, now U.S. Pat. No. 8,818,759, titled COMPUTER SYSTEM FOR REMOTE TESTING OF INFLATABLE PERSONAL RESTRAINT SYSTEMS; U.S. patent application Ser. No. 11/468,170, filed Aug. 25, 2014, titled COMPUTER SYSTEM FOR REMOTE TESTING OF INFLATABLE PERSONAL RESTRAINT SYSTEMS; U.S. patent application Ser. No. 13/424,197, filed Mar. 19, 2012, now U.S. Pat. No. 8,523,220, titled STRUCTURE MOUNTED AIRBAG ASSEMBLIES AND ASSOCIATED SYSTEMS AND METHODS; U.S. patent application Ser. No. 14/384,655, filed Sep. 11, 2014, titled STRUCTURE MOUNTED AIRBAG ASSEMBLIES AND ASSOCIATED SYSTEMS AND METHODS; U.S. Provisional Patent Application No. 62,041,549, filed Aug. 25, 2014, titled AIRBAG ASSEMBLY FOR LEG FLAIL PROTECTION AND ASSOCIATED SYSTEMS AND METHODS; and U.S. patent application Ser. No. 14/505,277, filed Oct. 2, 2014, titled ACTIVE POSITIONING AIRBAG ASSEMBLY AND ASSOCIATED SYSTEMS AND METHODS.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I claim:

1. A seating area in an aircraft, the seating area comprising:
a seat for an occupant;
an object positioned generally forward of the seat; and
a restraint configured to be fastened around the occupant's body to secure the occupant in the seat, wherein the restraint includes at least one extension feature configured to allow the occupant's body to move toward the object before impacting the object in response to a dynamic event.

2. The seating area of claim 1 wherein the extension feature enables the restraint to increase in length in response to a dynamic load from the occupant's body.

3. The seating area of claim 1 wherein the extension feature enables the restraint to increase in length a distance of from about 4 inches to about 10 inches in response to a dynamic load from the occupant's body.

4. The seating area of claim 1 wherein the restraint is a 2-point restraint configured to extend around the occupant's waist, and wherein the extension feature is configured to allow the occupant's waist to move toward the object in response to the dynamic event.

5. The seating area of claim 1 wherein the extension feature is configured to allow the occupant's body to move toward the object a distance of from about 2 inches to about 5 inches in response to the dynamic event.

6. The seating area of claim 1, further comprising a structure fixedly attached to a floor of the seating area, wherein the object is an airbag that inflates and deploys between the structure and the occupant in response to the dynamic event.

7. The seating area of claim 1, further comprising a structure fixedly attached to a floor of the seating area, wherein the object is an airbag that is stowed in a housing carried by the structure, and wherein the airbag deploys from the housing and inflates between the structure and the occupant in response to the dynamic event.

8. The seating area of claim 1 wherein the seat has a centerline oriented at an angle relative to a longitudinal axis of the aircraft, and wherein the object is offset from the centerline of the seat.

9. The seating area of claim 1 wherein the restraint includes:
a first web portion;
a second web portion;
a web connector attached to the first web portion;
a buckle assembly attached to the second web portion, wherein the buckle assembly is configured to releasably engage the web connector to fasten the first and second web portions around the occupant's waist, and wherein the at least one extension feature is operably coupled to at least one of the first web portion or the second web portion.

10. The seating area of claim 1 wherein the restraint includes:
a first web configured to be fixedly attached to at least one anchor point proximate the seat, wherein the at least one extension feature is operably coupled to the first web;
a second web attached to the first web, the second web having a first end portion and a second end portion;
a web connector attached to the first end portion of the second web;
a buckle assembly attached to the second end portion of the second web, wherein the buckle assembly is configured to releasably engage the web connector to fasten the second web around the occupant's waist.

11. A restraint system for use with an aircraft seat, the restraint system comprising:
a first web configured to be attached to at least one of the aircraft seat or a portion of the aircraft adjacent the aircraft seat;
a second web attached to the first web, the second web having a first end portion and a second end portion;
a web connector attached to the first end portion of the second web;
a buckle assembly attached to the second end portion of the second web, wherein the buckle assembly is configured to releasably engage the web connector to fasten the second web around the waist of an occupant sitting in the aircraft seat; and
means for extending the first web in response to a tension load in the first web.

12. The restraint system of claim 11 wherein the first web includes a first end portion and a second end portion, wherein the first end portion of the first web is configured to be fixedly attached to an anchor point on one side of the aircraft seat, and wherein the second end portion of the first web is configured to be attached to a second anchor point on an opposite side of the aircraft seat.

13. The restraint system of claim 11 wherein the means for extending the first web are incorporated into the first web.

14. The restraint system of claim 11 wherein the means for extending the first web include a portion of the first web that is folded over on itself and fastened together by stitching, and wherein the stitching is configured to break under the tension load in the first web and release the portion of the first web that is folded over on itself.

15. The restraint system of claim 11 wherein the first web includes an end portion, wherein the restraint system further comprises an attachment fitting fixedly attaching the end portion of the first web to an anchor point at least proximate the aircraft seat, and wherein the means for extending the first web is incorporated into the attachment fitting.

16. The restraint system of claim 11 wherein the first web includes an end portion, and wherein the restraint system further comprises:
an attachment fitting fixedly attached to the end portion of the first web, wherein the means for extending the first web include—
an elongate slot in the attachment fitting, the elongate slot having a first end portion spaced apart from a second end portion, and the elongate slot further having a first sidewall spaced apart from a second sidewall by a first width; and
a bolt extending through the first end portion of the elongate slot and fixedly attaching the attachment fitting to an anchor point at least proximate the aircraft seat, wherein the bolt has a second width that is greater than the first width, and wherein the tension load in the first web causes the attachment fitting to move relative to the bolt until the bolt comes to bear against the second end portion of the elongate slot.

17. The restraint system of claim 11, further comprising an airbag configured to be carried on a structure positioned generally forward of the aircraft seat, wherein the airbag is further configured to inflate and deploy between the structure and the occupant in response to a dynamic event that accelerates the occupant toward the structure, wherein the acceleration of the occupant toward the structure causes the tension load in the first web.

18. A method of protecting an occupant sitting in an aircraft seat positioned behind a structure during a dynamic event, the method comprising:
providing the aircraft seat with a 2-point restraint configured to be fastened around the occupant's waist; and
controlling movement of the occupant toward the structure in response to the dynamic event, wherein controlling movement of the occupant includes—
restricting the 2-point restraint to a first length if the dynamic event is less than a threshold magnitude; and
enabling the 2-point restraint to extend to a second length, greater than the first length, if the dynamic event is greater than the threshold magnitude.

19. The method of claim 18, wherein enabling the 2-point restraint to extend to a second length, greater than the first length, if the dynamic event is greater than the threshold magnitude controls an angle of the occupant's torso relative to the structure as the occupant moves toward the structure during the dynamic event.

20. The method of claim 18, further comprising:
providing an airbag; and
inflating the airbag between the structure and the occupant if the dynamic event is greater than the threshold magnitude, wherein controlling movement of the occupant includes controlling the orientation of the occupant at impact with the airbag.
